(19) United States
(12) Patent Application Publication
(10) Pub. No.: US 2009/0176157 A1
(43) Pub. Date: Jul. 9, 2009

(54) AA AND AAA ALKALINE DRY BATTERIES

(76) Inventors: Hidekatsu IZUMI, Osaka (JP); Fumio KATO, Osaka (JP); Seiji WADA, Osaka (JP); Yasuhiko BITO, Osaka (JP); Eiji TANO, Osaka (JP)

Correspondence Address: MCDERMOTT WILL & EMERY LLP, 600 13TH STREET, NW, WASHINGTON, DC, 20005-3096, US

(21) Appl. No.: 12/341,622

(22) Filed: Dec. 22, 2008

Related U.S. Application Data
(60) Provisional application No. 61/022,670, filed on Jan. 22, 2008.

(30) Foreign Application Priority Data
Dec. 27, 2007 (JP) 2007-337709
Jan. 11, 2008 (JP) 2008-004709

(51) Int. Cl. H01M 6/04

(52) U.S. Cl. 429/188

(57) ABSTRACT

In a battery casing, there are accommodated a positive electrode containing manganese dioxide, a negative electrode containing zinc, and an electrolyte containing an aqueous solution of potassium hydroxide. The negative electrode contains bismuth of 100 ppm or less. In an AA dry battery, the amount of zinc in the negative electrode is 4.00 g or more, and the weight of the electrolyte is 4.00 g or more. In an AAA dry battery, the amount of zinc in the negative electrode is 1.71 g or more, and the weight of the electrolyte is 1.77 g or more.

### BACKGROUND OF THE INVENTION

1. Field of the Invention

The present invention relates to AA and AAA alkaline dry batteries.

2. Description of Related Art

Alkaline dry batteries, which have electric capacities lager than manganese dry batteries, exhibit efficient discharge characteristics even in long term use at a large current and are therefore being used widely. In response to a demand for dry batteries having further larger electric capacities, researches and developments have been promoted for increasing the electric capacities.

In order to increase the electric capacity, in general, a method can be considered in which the total amount of active materials in one dry battery is increased.

For example, Japanese Unexamined Patent Application Publication (Translation of PCT Application) No. 2002-523874 discloses a technique for increasing the lifetime of a dry battery by increasing the internal volume of a casing up to 88.4% or more of the total volume of the dry battery to increase the total amount of the electric chemical materials.

### SUMMARY OF THE INVENTION

### Problems that the Invention is to Solve

An increase in amount of the active materials by the technique disclosed in the above-mentioned publication, however, involves considerable temperature rise within the dry battery upon short circuit of the dry battery when compared with a dry battery including less amount of the active materials, thereby presenting a problem of safety.

For tackling this problem, Japanese Unexamined Patent Application Publication 2004-47321 discloses an alkaline dry battery in which abrupt temperature rise upon abnormality occurrence is prevented by setting the KOH concentrations of the alkaline electrolyte contained in a positive electrode mixture and in a negative electrode mixture to be 45 wt % or more and 35 wt % or less, respectively.

It is much difficult, however, to keep the different concentrations of the alkaline electrolyte in the positive electrode mixture and in the negative electrode mixture. Use or only reservation of the dry battery allows the KOH to move in the dry battery so that the concentrations become equal to each other, thereby canceling the effect of preventing abrupt temperature rise.

### Means for Solving the Problem

The present invention has been made in view of the foregoing and has its object of providing an AA alkaline dry battery and an AAA alkaline dry battery in a simple construction capable of suppressing temperature rise therein upon short circuit.

In order to solve the above problem, the present invention provides an AA alkaline dry battery which includes: a positive electrode containing manganese dioxide; a negative electrode containing zinc of 4.00 g or more and bismuth of 100 ppm or less; and an electrolyte of 4.00 g or less containing an aqueous solution of potassium hydroxide.

The electrolyte may contain a phosphate-based surfactant in a range between 300 ppm and 3000 ppm, both inclusive, with respect to a weight of the zinc in the negative electrode, the phosphate-based surfactant having an average molecular weight in a range between 100 and 500, both inclusive.

The electrolyte may have a concentration of potassium hydroxide in a range between 26.0 wt % and 33.5 wt %, both inclusive.

The manganese dioxide may have a weight of 9.30 g or more.

An AAA alkaline dry battery according to the present invention includes: a positive electrode containing manganese dioxide; a negative electrode containing zinc of 1.71 g or more and bismuth in a range between 5 ppm and 100 ppm, both inclusive; and an electrolyte of 1.77 g or more containing an aqueous solution of potassium hydroxide, the electrolyte having a concentration of potassium hydroxide in a range between 26.0 wt % and 34.0 wt %, both inclusive.

The electrolyte may contain a phosphate-based surfactant in a range between 300 ppm and 3000 ppm, both inclusive, with respect to a weight of the zinc in the negative electrode, the phosphate-based surfactant having an average molecular weight in a range between 100 and 500, both inclusive.

The manganese dioxide may have a weight of 4.05 g or more.

### BRIEF DESCRIPTION OF THE DRAWINGS

FIG. 1 is a partially exploded sectional view of an AA alkaline dry battery in accordance with an embodiment.

FIG. 2 is a table listing design values and analysis values of materials composing dry battery used in Embodiment 1.

FIG. 3 is a table listing results of discharge characteristics evaluation in Embodiment 1.

FIG. 4 is a table listing maximum temperatures (standardized values) reaching upon short circuit in Embodiment 1.

FIG. 5 is a table listing gas generation rate in negative electrodes in Embodiment 1.

FIG. 6 is a table listing design values and analysis values of materials composing dry battery used in Embodiment 2.

FIG. 7 a table listing results of discharge characteristics evaluation in Embodiment 2.

FIG. 8 is a table listing maximum temperatures (standardized values) reaching upon short circuit in Embodiment 2.

FIG. 9 is a table listing gas generation rate in negative electrodes in Embodiment 2.

### BEST MODE FOR CARRYING OUT THE INVENTION

Prior to description of embodiments of the present invention, the course for reaching the present invention which the inventors took will be described.

As described above, it has been tried to pack the active materials as much as possible into one dry battery for increasing the lifetime and the capacity, which has involved various problems instead. To tackle these problems, the present inventors have carried out various examinations. As one of such examinations, the amount of Bi (bismuth), which is contained in the negative electrode for anti-corrosion, was examined to find that Bi in amount of a given range suppresses temperature rise in the dry battery upon short circuit.

### Embodiment 1

Embodiment 1 of the present invention will be described below in detail with reference to the accompanying drawings. In the drawings, the same reference numerals are assigned to components having substantially the same functions for the sake of simple description. It is noted that the following embodiments are mare examples of the present invention and the present invention is not limited to these examples.

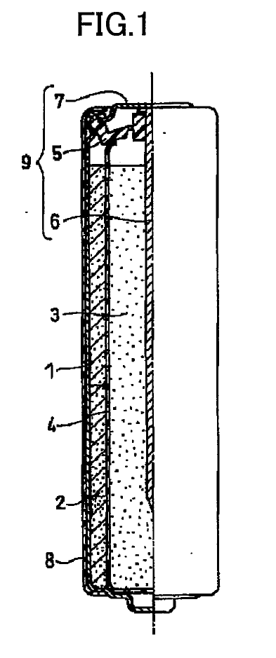

FIG. 1 is a partially exploded sectional view of an AA alkaline dry battery in accordance with the present embodiment. In a battery casing (case) 1 of the AA alkaline dry battery, there are accommodated a positive electrode 2 containing manganese dioxide, a negative electrode 3 containing zinc, and an electrolyte (not shown) containing an aqueous solution of potassium hydroxide.

A construction of the AA alkaline dry battery in accordance with the present embodiment will be described further in detail. The hollowed cylindrical positive electrode 2 is in contact with the inner wall of the bottomed cylindrical battery casing 1 serving also as a positive electrode terminal. The negative electrode 3 is arranged in the hollowed part of the positive electrode 2 with a bottomed cylindrical separator 4 interposed. The opening part of the battery casing 1 is sealed by a sealing unit 9. The sealing unit 9 includes a negative electrode terminal plate 7 closing the opening part of the battery casing 1, a linear negative electrode current collector 6 welded to the negative electrode terminal plate 7, and a resin-made sealing member 5. The negative electrode current collector 6 is inserted in the central part of the negative electrode 3. The electrolyte is permeated through the positive electrode 2, the separator 4, and the negative electrode 3 and is therefore not shown.

The battery casing 1 is obtained by press-forming, for example, a nickel plated steel plate into a predetermined shape of a predetermined dimension by a known method disclosed in Japanese Unexamined Patent Application Publication 60-180058, Japanese Unexamined Patent Application Publication 11-144690, Japanese Unexamined Patent Application Publication 2007-27046, Japanese Unexamined Patent Application Publication 2007-66762, or the like. In order to pack the active materials into the dry battery as much as possible, the outer diameter of the battery casing 1 is set at 13.90 mm or larger, wherein the upper limit thereof is 14.10 mm. Of the above listed publications, the latter two publications are preferable because the internal volume of the dry battery can be increased so that the component materials of the positive electrode 2 and the negative electrode 3 can be packed therein much more. When the side face (a cylindrical part) of the battery casing 1 has a thickness of 0.18 mm or smaller, the internal volume of the battery casing 1 increases preferably.

The positive electrode 2 contains mainly a positive electrode active material containing manganese dioxide powder and a conductive material, such as graphite powder or the like, wherein the weight of manganese dioxide in one dry battery is 9.30 g or more. Containing much manganese dioxide leads to excellent discharge characteristics (long lifetime). Since the outer dimension of the AA alkaline dry battery is set in accordance with the standard, there is an upper limit of the amount of manganese dioxide, similarly to zinc and the electrolyte, which will be described later.

The negative electrode 3 is a substance obtained by mixing a negative electrode active material, such as zinc powder, zinc alloy powder, or the like with a gelled material of which main material is a mixture of electrolyte and a gelling agent, such as sodium polyacrylate or the like. The amount of zinc is 4.00 g or more. In the negative electrode 3, Bi of 100 ppm or less is contained. The amount of Bi is preferably 5 ppm or more for anti-corrosion. As the negative electrode active material, a zinc alloy powder excellent in anti-corrosion is preferable. Further, none of mercury, cadmium, and lead is preferably added in view of environment. The zinc alloy may contain, for example, at least one of indium, aluminum, and bismuth.

The separator 4 is made of a non-woven fabric obtained by intermingling mainly polyvinyl alcohol fiber and rayon fiber, for example, so as to withstand alkalinity of the electrolyte and so as to allow the electrolyte to pass therethrough.

The electrolyte is an alkaline aqueous solution of 4.00 g or more, of which KOH concentration is in the range between 26.0 wt % and 33.5 wt %, both inclusive. The KOH concentration can be obtained by titrating the electrolyte present inside a completed dry battery. A low KOH concentration might reduce the viscosity of the electrolyte to increase its mobility in the dry battery, thereby increasing the discharge duration. There is further contained a phosphate-based surfactant in the range between 300 ppm and 3000 ppm, both inclusive, of which average molecular weight is in the range between 100 and 500, both inclusive.

The phosphate-based surfactant is one of anionic surfactants which suppress gas generation caused due to zinc corrosion. In the present embodiment, though gas generation involves no practical problem even without adding such an anionic surfactant, the phosphate-based surfactant is added for preventing gas generation further definitely because the amount of Bi contained for exhibiting an anti-corrosion effect is set small. The effect of the anionic surfactant premises the following mechanism. Namely, H₂O receives electrons from zinc to generate a hydrogen gas inside an ordinary dry battery free from impurity, wherein the hydrophilic part of the anionic surfactant covers the surface of zinc while the hydrophobic part thereof faces outward, thereby suppressing invasion that H₂O tries to be in contact with the surface of zinc to thus suppress generation of the hydrogen gas.

The function of the anionic surfactant will be described further in detail. In a strong alkaline electrolyte as used in a negative electrode of an alkaline dry battery, OH⁻ is trapped at the metal surface to allow the charge of the zinc surface to be minus, so that the electrostatic attractive force does not work between the negatively-charged hydrophilic part of the anionic surfactant and zinc. However, the solubility of the anionic surfactant in the strong alkaline electrolyte is much smaller than that of a neutral aqueous solution, and therefore, the anionic surfactant insoluble in the electrolyte is turned out of the electrolyte to occupy the electrolyte/zinc interface. The thus arranged anionic surfactant, however, does not inhibit supply of OH⁻ ion to zinc, which is necessary to discharge reaction, and diffusion of zinc acid ion. This might be because change in electric field near the zinc surface at discharge breaks instantly the arrangement of the anionic surfactant.

Of such anionic surfactants, one containing alkyl phosphate salt is admitted to exhibit the effect the most and is therefore used in the present embodiment. Alternatively, any anionic surfactant other than phosphate-based one, such as one basically containing alkylsulfuric acid salt may be used.

The anionic surfactant may contain monovalent or bivalent anion, such as ROPO₃Na₂, ROPO₃K₂, (RO)₂PO₂Na (wherein R is an alkyl group), or any one or two of H, K, Na, Ca and the like may be used as a counter cation. It is preferable that the anionic surfactant has an average molecular weight of 100 and 500, both inclusive, because the effect of suppressing the aforementioned invasion that H₂O tries to be in contact with the zinc surface is enhanced. The alkyl group R may be linear or branched (an iso-alkyl group or the like) or may have an ethylene oxide structure, such as R′(CH₂CH₂O)ₙPO₃Na₂. When the content of the anionic surfactant is in the range between 300 ppm and 3000 ppm, both inclusive, the aforementioned mechanism works the most effectively. An anionic surfactant of alkyl phosphate salt, which is stable in a concentrated alkaline electrolyte, is preferable as an additive to the negative electrode.

To the electrolyte, ZnO is also added. The concentration thereof is preferably 3 wt % or lower, more preferably, 1.5 wt % or lower. It is preferable that ZnO of 0.2 wt % or higher is contained in the electrolyte.

### Working Example 1

First, a zinc alloy powder containing Al of 0.005 wt %, Bi of 0.005 wt %, and In of 0.020 wt % with respect to the weight of zinc was prepared as a zinc alloy powder by a gas atomizing method. The thus prepared zinc alloy powder was classified with the use of a screen for adjusting the grain size thereof in the range between 70 and 300 meshes, wherein the ratio thereof having a grain diameter of 200 meshes (75 μm) or smaller is 30%. The resultant zinc alloy powder was used as a negative electrode active material.

Next, polyacrylic acid and sodium polyacrylate of 2.2 wt % each were added to and were mixed with 100 weight parts of an aqueous solution of potassium hydroxide of 33 wt % (containing ZnO of 1 wt %) for gelling, thereby obtaining a gelled electrolyte. The thus obtained gelled electrolyte was allowed to stand for 24 hours for sufficient maturation.

Thereafter, there was added to and mixed sufficiently with a predetermined amount of the thus obtained gelled electrolyte the prepared zinc alloy powder of 1.92 times at weight ratio, indium hydroxide of 0.025 weight part with respect to the zinc alloy powder of 100 weight parts (0.0164 weight part as metal indium), and the anionic surfactant (alcohol sodium phosphate ester having an average molecular weight of approximately 210) of 0.1 weight part, thereby obtaining a gelled negative electrode.

Subsequently, an electrolytic manganese dioxide (HHTF, a product by TOSOH CORPORATION) and a graphite (SP-20, a product by Nippon Graphite Industries, ltd.) were blended at a weight ratio of 94:6. With the thus mixed powder of 100 weight parts, an electrolyte (an aqueous solution of potassium hydroxide of 33 wt % containing ZnO of 1 wt %) of 1.5 weight parts and polyethylene binder of 0.2 weight part are mixed. Then, the mixture was stirred and mixed evenly by a mixer, and was sized to have a given grain size. The thus obtained grain substance was press formed by a hollowed cylindrical mold to obtain a positive electrode mixture in the form of a pellet.

Next, a sample AA alkaline dry battery was manufactured. As shown in FIG. 1, two pellets of the thus obtained positive electrode mixture (each weight thereof is 5.65 g) were inserted into the battery casing 1, and pressure was applied again thereto in the battery casing 1 to allow them to adhere to the inner face of the battery casing 1. Then, after the separator 4 and a bottom plate for bottom insulation were inserted inside the positive electrode mixture pellets, the electrolyte of 1.8 g prepared as above was injected. Thereafter, the gelled negative electrode 3 was filled inside the separator 4. The resin-made sealing member 5, the negative electrode terminal plate 7, and the negative electrode current collector 6 were inserted into the negative electrode 3, and the open end of the battery casing 1 was crimped to the peripheral part of the negative electrode terminal plate 7 with the edge of the sealing member 5 interposed, thereby sealing the opening part of the battery casing 1. The outer surface of the battery casing 1 was covered with an outer label 8 to thus complete an AA alkaline dry battery.

As a material of the resin-made sealing member, 6,12-nylon was used. A tin plated copper wire was used as the negative electrode current collector. An alkaline dry battery separator by KURARAY CO., LTD. (a composite fiber made of vinylon and tencel) was used as the separator.

### Comparative Example 1

An AA alkaline dry battery was manufactured by the same manner as in Working Example 1 except that a zinc alloy powder containing Al of 0.005 wt %, Bi of 0.015 wt %, and In of 0.020 wt % with respect to the weight of zinc was used as the negative electrode active material.

### Comparative Example 2

An AA alkaline dry battery was manufactured by the same manner as in Working Example 1 except that an aqueous solution of potassium hydroxide of 36 wt % (containing ZnO of 1 wt %) was used as the electrolyte.

Dry battery evaluating methods will be described next.

(1) Zn amount, MnO₂ amount, KOH concentration, ZnO concentration, and Bi amount

The weight of a dry battery was measured, the outer label was removed, and the sealed part of the battery was cut open. Then, the sealing member was taken out, and the negative electrode gel and the electrolyte adhering thereto were washed out into a beaker with the use of ion-exchanged water. After all the negative electrode gel in the battery was put into the beaker, the separator was taken out from the battery, and the negative electrode gel and the electrolyte adhering thereto were washed out into the beaker with the use of the ion-exchanged water. The sealing member and the separator were dried, and their weights were measured. The weight of the outer label was also measured.

The negative electrode gel in the beaker was washed with water and decantationed about ten times to separate KOH (potassium hydroxide) into supernatant liquid from almost all the negative electrode gel. The thus obtained supernatant liquid was subjected to neutralization titration by hydrochloric acid of 1N to obtain the amount (a1) of KOH in the supernatant liquid. A gelling material was removed from the residual negative electrode gel by washing with (1+1)NH₄OH and was dried, and the weight of the zinc powder in the negative electrode was measured.

The dissolved ZnO was precipitated and suspended at neutralization titration. After hydrochloric acid was added to the supernatant liquid after neutralization titration to dissolve the suspended matter, a buffering solution of acetic acid/ammonium acetate and an XO indicator were added. Then, titration was performed with the use of 1/100 M-EDTA solution to obtain the amount (b1) of dissolved ZnO.

The positive electrode mixture was taken out from the battery casing and was dried, and the weights of the battery casing and the positive electrode mixture were measured. Then, the positive electrode mixture was crushed, a concentrated hydrochloric acid was added thereto, MnO₂ was dissolved by heating, and then, the resultant substance was filtered to be separated from residue. The residue not dissolved in hydrochloric acid (a graphite conductive material and a binder component in the positive electrode mixture) was dried, and its weight was measured.

A given amount of a solution to which MnO₂ is dissolved was fractionated, (1+1)NH₄OH was dripped thereto so that the solution becomes pH 3, and hydrogen peroxide was added and stirred. Concentrated NH₄OH was further added and stirred to precipitate MnO₂. The thus precipitated substance was filtered, was washed with water, and was then dissolved completely into hydroxylamine hydrochloride of 10 W/V % and (1+1) hydrochloric acid. Then, triethanolamine, an ammonium chloride/ammonia-based buffering solution, and a TPC indicator were added, and then, the resultant substance was titrated with the use of 1/20 M-EDTA solution to obtain the amount of MnO₂. From the thus obtained amount of MnO₂, the amount of MnO₂ present in one dry battery was calculated. The amount of electrolytic manganese dioxide (EMD) used in the dry battery was calculated from the thus obtained amount of MnO₂ (the content of pure MnO₂ in EDM was approximately 93%).

Subsequently, a given amount of the solution to which MnO₂ is dissolved was fractionated again, and was analyzed by ICP (inductively coupled plasma) spectrometry (standard addition method) to quantify the amount of Zn, and then, the amount (b2) of ZnO contained in the positive electrode mixture was calculated. The same solution was analyzed by atomic absorption analysis (standard addition method) to quantify the amount of potassium, and then, the amount (a2) of KOH contained in the positive electrode mixture was calculated.

According to the above measurements, the weight (c) of the electrolyte in the dry battery was obtained by subtracting from the total weight of the battery the total weight of the components (the total weight of the outer label, the battery casing, the sealing member, the separator, the zinc powder and the gelling agent, the EMD, and the residue not dissoluble in hydrochloric acid) other than the electrolyte. The KOH concentration (wt %) (=(a1+a2)/c) of the electrolyte and the ZnO concentration (wt %) (b1+b2)/c) thereof were obtained from the total amount (a1+a2) of KOH and the total amount (b1+b2) of ZnO in the dry battery, respectively.

It is noted that the amount of Bi contained in the zinc alloy powder can be obtained in such a manner that a predetermined weight of the zinc alloy powder separated by the aforementioned method is dissolved in an acid and is subjected to IPC spectrometry.

(2) Discharge Characteristics

(2-1) Middle-Rate Discharge Characteristics

The dry battery was connected to a test load and was allowed to discharge at 250 mA for one hour per day in a thermostatic bath at 20° C. The battery voltage during the discharge was recorded, and the discharge duration until the battery voltage became equal to or lower than 0.9 V was obtained.

(2-2) High-Rate Discharge Characteristics

Under an isothermal atmosphere of 21±2° C., pulse discharge repeating discharge at 1.5 W for two seconds and discharge at 0.65 W for 28 seconds were performed 10 cycles per one hour. The discharge duration until the closed circuit voltage reached 1.05 V was checked. The discharge test prescribed in ANSI C18.1M was applied mutatis mutandis to this evaluation.

(3) Maximum Temperature Reaching Upon Short Circuit

Under an isothermal atmosphere of 21±2° C., the temperature of the dry battery was raised by forcedly causing short circuit in a single dry battery or four dry batteries connected to each other in series, and the maximum temperature of the batteries reaching at that time was measured by a thermocouple mounted at a predetermined part of the surface of the batteries.

(4) Gas Generation Rate in Negative Electrode

The gas generation rates of the gelled negative electrodes used in Working Example 1 and Comparative Examples 1 and 2 were obtained by the following method (see Japanese Unexamined Patent Application Publication 57-048635, Japanese Unexamined Patent Application Publication 7-245103, and Japanese Unexamined Patent Application Publication 2006-004900).

The gelled negative electrode of 5.00 g was put into a glass-made gas collecting jig composed of a plug of a graduated tubule and a container. Then, after fluid paraffin was allowed to flow thereinto to sink the negative electrode fully, the container was sealed by means of the plug of the glass-made jig with no air left therein. The glass-made jig was immersed into a thermostatic bath kept at 45° C., and was left for approximately three hours so that the temperature in the jig was kept constant. Under this state, the accumulated amount of gas generated within three days were measured, and the gas generation rate was calculated by the following expression. The test was performed five times for each example, and each average thereof was obtained.

Gas generation rate (μlitter/(g·day))=accumulated amount of gas generated in three days (μlitter)/(5(g)·3 (days))

The thus obtained evaluation results will be remarked next.

(Zn amount, MnO₂ amount, electrolyte amount, KOH concentration, ZnO concentration, and Bi amount)

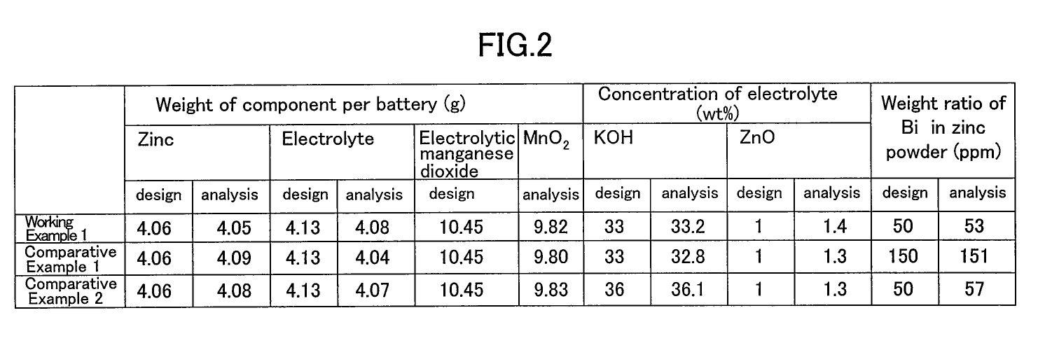

FIG. 2 is a table summarizing the design values of each component of the batteries used in Working Example 1 and Comparative Examples 1 and 2 and the analysis values (averages in each three batteries) obtained by the actual analysis in (1) for each three batteries. The table proves that the analysis values reflect the design values accurately.

(Discharge Characteristics)

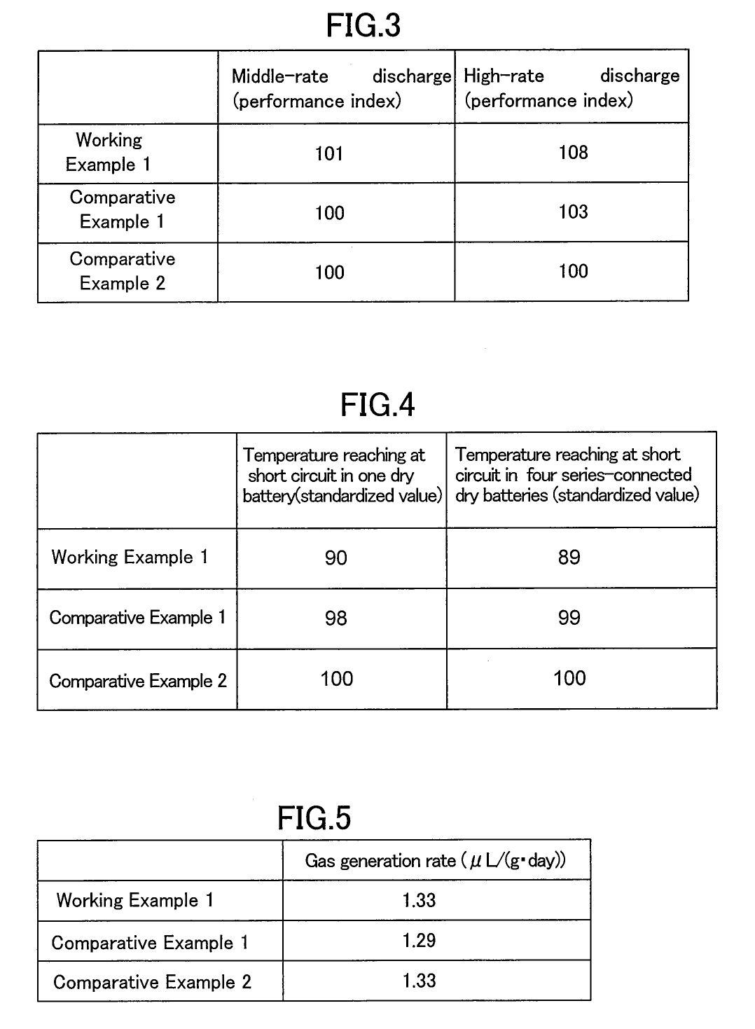

The results of the discharge characteristics evaluation are indicated in FIG. 3. As to the middle-rate discharge, one-point higher performance was recognized in Working Example 1 when compared with those in Comparative Examples 1 and 2. As to the high-rate discharge, it is recognized that Working Example 1 is five-point and eight-point higher in performance than Comparative Examples 1 and 2, respectively. Since Bi is a semimetal and has low conductivity, it serves as a discharge inhibitor when the amount thereof added to a Zn alloy is large. In Working Example 1, reduction in amount of Bi might increase the conductivity of the Zn alloy powder to suppress polarization of the negative electrode at discharge, thereby improving the discharge performance mainly in high rate discharge. Further, in Working Example 1, the low KOH concentration and low viscosity of the electrolyte might increase the ion conductance in the liquid to improve the discharge performance.

(Maximum Temperature Reaching Upon Short Circuit)

FIG. 4 indicates the maximum temperatures (standardized values) of the batteries reaching upon short circuit. In both one battery and four series-connected batteries, about ten-point temperature lowering was recognized in Working Example 1 from the maximum temperatures in Comparative Examples 1 and 2. Since Bi is a semimetal and has low conductivity, it serves as a discharge inhibitor when the amount thereof added to a Zn alloy is large to generate Joule heat at short circuit, namely, at forced discharge, thereby inviting heat accumulation in the dry battery. Accordingly, in Working Example 1 in which the amount of Bi is reduced, heat accumulation in the dry battery might be suppressed to suppress temperature rise in the battery. Similarly, reduction in KOH concentration might increase the ion conductance in the electrolyte to suppress heat accumulation in the dry battery, thereby suppressing temperature rise in the battery.

(Gas Generation Rate in Negative Electrode)

FIG. 5 shows the gas generation rates in the negative electrodes. It can be recognized that all the batteries indicate almost the same gas generation rate. The results in Working Example 1 and Comparative Example 1 lead to consideration that addition of the phosphate-based surfactant can suppress gas generation caused due to zinc corrosion even when the amount of Bi, which exhibits an anti-corrosion effect, is reduced.

### Embodiment 2

Embodiment 2 is directed to an AAA alkaline dry battery. The AAA alkaline dry battery of the present embodiment has almost the same shape and the same internal construction as the AA alkaline dry battery of Embodiment 1 shown in FIG. 1 except the amounts of the materials and the dimensions of the components, and therefore, description of the same details as in Embodiment 1 is omitted. Though not shown, the AAA alkaline dry battery of the present embodiment has the same construction as that shown in FIG. 1.

In the present embodiment, the thickness of the side part (cylindrical part) of the battery casing is preferably 0.2 mm or smaller for increasing the internal volume of the battery casing.

The positive electrode contains mainly a positive electrode active material containing manganese dioxide powder and a conductive material, such as graphite powder, and manganese dioxide in one dry battery is 4.05 g or more. Containing much manganese dioxide results in excellent discharge characteristics (long lifetime). Since the outer dimension of the AAA alkaline dry battery is set in accordance with the standard, there is an upper limit of the amount of manganese dioxide, likewise zinc and the electrolyte, which will be described later.

The negative electrode is obtained by mixing a negative electrode material, such as zinc powder, zinc alloy powder, or the like with a gelled material of which main material is a mixture of electrolyte and a gelling agent, such as sodium polyacrylate. The amount of zinc is 1.71 g or more. Further, Bi in the range between 5 ppm and 100 ppm, both inclusive, is contained in the negative electrode. A zinc alloy powder excellent in anti-corrosion is preferably used as the negative electrode active material. Further, none of mercury, cadmium, and lead is preferably contained in view of environment. The zinc alloy may contain, for example, at least one of indium, aluminum, and bismuth.

The electrolyte is an alkaline aqueous solution of 1.77 g or more, of which KOH concentration is in the range between 26.0 and 34.0 wt %, both inclusive. The KOH concentration can be obtained by analyzing the electrolyte present in a completed dry battery. A low KOH concentration might reduce the viscosity of the electrolyte to increase its mobility in the dry battery, thereby increasing the discharge duration. When the KOH concentration is set at the above value, inactivation of the negative electrode is liable to be caused to stop its reaction in continued over-current discharge at short circuit, which means that an effect of suppressing temperature rise upon short circuit can be obtained.

### Working Example 2

The same negative electrode, positive electrode, separator, and electrolyte as those in Working Example 1 were prepared.

Subsequently, a sample AAA alkaline dry battery was prepared. Two pellets of the positive electrode mixture (each weight thereof is 2.46 g) were inserted into the battery casing, and pressure was applied again thereto in the battery casing 1 to allow them to adhere to the inner face of the battery casing. Then, after the separator and a bottom plate for bottom insulation were inserted inside the positive electrode mixture pellets, the electrolyte of 0.85 g was injected. Thereafter, the gelled negative electrode was filled inside the separator. The resin-made sealing member, the negative electrode terminal plate, and the negative electrode current collector were inserted into the negative electrode, and the open end of the battery casing was crimped to the peripheral part of the negative electrode terminal plate with the edge of the sealing member interposed, thereby sealing the opening part of the battery casing. The outer surface of the battery casing was covered with an outer label to thus complete an AAA alkaline dry battery.

As a material of the resin-made sealing member, 6,12-nylon was used. A tin plated copper wire was used as the negative electrode current collector.

### Comparative Example 3

An AAA alkaline dry battery was prepared by the same manner as in Working Example 2 except that a zinc alloy powder containing Al of 0.005 wt %, Bi of 0.015 wt %, and In of 0.020 wt % with respect to the weight of zinc was used as the negative electrode active material.

### Comparative Example 4

A commercially-available AAA alkaline dry battery was used as a dry battery of Comparative Example 4.

Dry battery evaluating methods will be described next.

(1) Zn amount, MnO₂ amount, KOH concentration, ZnO concentration, and Bi amount

The method is the same as that in Embodiment 1.

(2) Discharge Characteristics

(2-1) Middle-Rate Discharge Characteristics

The dry battery was connected to a test load and was allowed to discharge at 100 mA for one hour per day in a thermostatic bath at 20° C. The battery voltage during the discharge was recorded, and the discharge duration until the battery voltage became equal to or lower than 0.9 V was obtained.

(2-2) High-Rate Discharge Characteristics Under an isothermal atmosphere of 21±2° C., pulse discharge repeating discharge at 0.9 W for two seconds and discharge at 0.39 W for 28 seconds were performed 10 cycles per one hour. The discharge duration until the closed circuit voltage reached 1.05 V was checked. The discharge test defined in ANSI C18.1M for an alkaline dry battery was applied mutatis mutandis to this evaluation.

(3) Maximum Temperature Reached Upon Short Circuit

The same evaluating method as in Embodiment 1 was employed.

(4) Gas Generation Rate in Negative Electrode

The same evaluating method as in Embodiment 1 was employed.

The thus obtained evaluation results will be remarked next.

(Zn amount, MnO₂ amount, electrolyte amount, KOH concentration, ZnO concentration, and Bi amount)

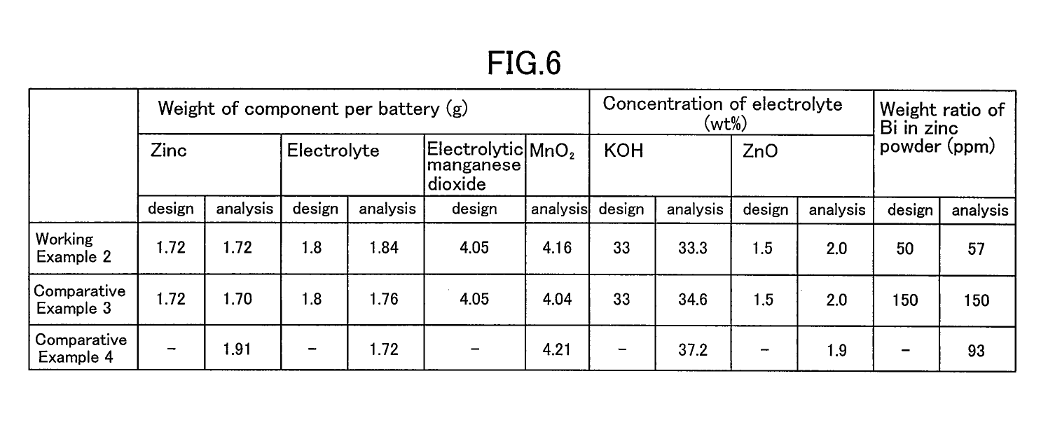

FIG. 6 is a table summarizing the design values of each component of the batteries used in Working Example 2 and Comparative Examples 3 and 4 and the analysis values (averages in each three batteries) obtained by the actual analysis in (1) for each three batteries. The table proves that the analysis values reflect the design values accurately.

(Discharge Characteristics)

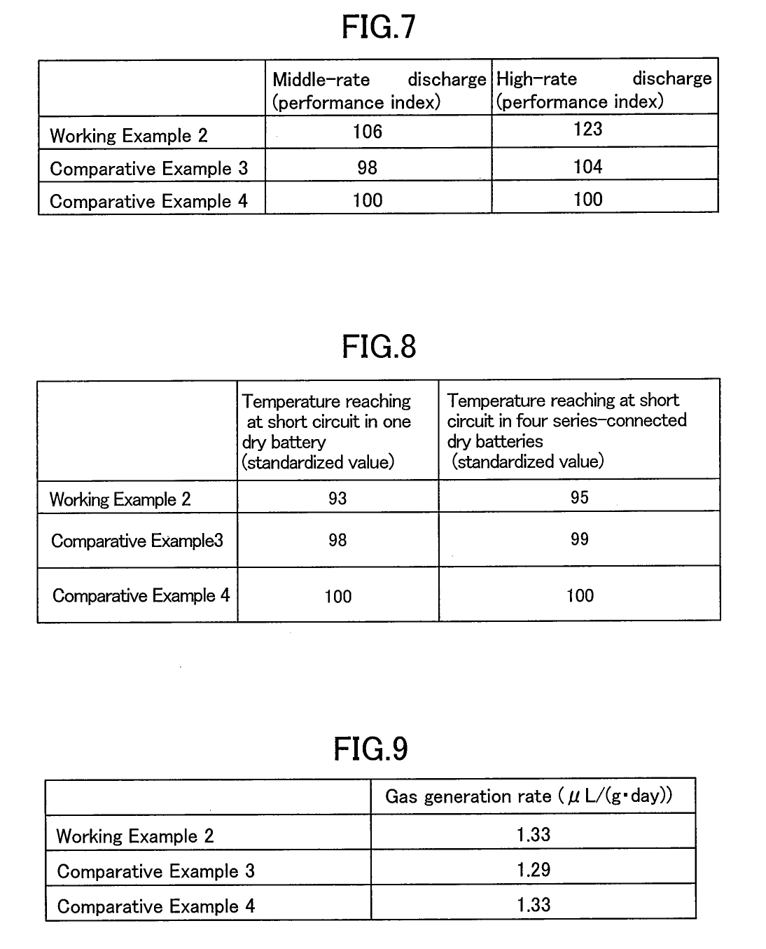

The discharge characteristics evaluation results are indicated in FIG. 7. As to the middle-rate discharge, it is recognized that the performance in Working Example 2 is eight-point and six-point higher than those in Comparative Examples 3 and 4, respectively. As to the high-rate discharge, it is recognized that the performance in Working Example 1 is 19-point and 23-point higher than those in Comparative Examples 3 and 4, respectively. Since Bi is a semimetal and has low conductivity, it serves as a discharge inhibitor when the amount thereof added to a Zn alloy is large. In Working Example 2, reduction in amount of Bi might increase the conductivity of the Zn alloy powder to suppress polarization of the negative electrode at discharge, thereby improving the discharge performance mainly in high rate discharge. Further, in Working Example 2, the low KOH concentration and the low viscosity of the electrolyte might increase the ion conductance in the liquid to improve the discharge performance.

(Maximum Temperature Reaching Upon Short Circuit)

FIG. 8 indicates the maximum temperatures (standardized values) of the batteries reaching upon short circuit. In both one dry battery and four series-connected dry batteries, about five-point temperature lowering was recognized in Working Example 2 from the maximum temperatures in Comparative Examples 3 and 4. Since Bi is a semimetal and has low conductivity, it serves as a discharge inhibitor when the amount thereof added to a Zn alloy is large to generate Joule heat at short circuit, namely, at forced discharge, thereby inviting heat accumulation in the dry battery. Accordingly, in Working Example 2 in which the amount of Bi is reduced, heat accumulation in the dry battery might be suppressed to suppress temperature rise in the battery. Similarly, reduction in KOH concentration might increase the ion conductance in the electrolyte to suppress heat accumulation in the dry battery, thereby suppressing temperature rise in the battery.

(Gas Generation Rate in Negative Electrode)

FIG. 9 shows the gas generation rates in the negative electrodes. It can be recognized that all the batteries indicate almost the same gas generation rate. The results in Working Example 2 and Comparative Example 3 lead to consideration that addition of the phosphate-based surfactant can suppress gas generation caused due to zinc corrosion even when the amount of Bi, which exhibits an anti-corrosion effect, is reduced.

As described above, the AA alkaline dry battery and the AAA alkaline dry battery in accordance with the present invention suppress temperature rise caused due to short circuit and are therefore useful as large-capacity alkaline dry batteries.

In addition, the content of Bi in the negative electrode is set at 100 ppm or less in the AA alkaline dry battery to enable suppression of temperature rise upon short circuit even when each amount of zinc and the electrolyte is 4.00 g or more. As well, the content of Bi in the negative electrode is set in the range between 5 and 100 ppm, both inclusive, in the AAA alkaline dry battery to enable suppression of temperature rise upon short circuit even when the amounts of zinc and the electrolyte are 1.71 g or more and 1.77 g or more, respectively.

What is claimed is:

1. An AA alkaline dry battery, comprising:
a positive electrode containing manganese dioxide;
a negative electrode containing zinc of 4.00 g or more and bismuth of 100 ppm or less; and
an electrolyte of 4.00 g or less containing an aqueous solution of potassium hydroxide.

2. The AA alkaline dry battery of claim 1, wherein
the electrolyte contains a phosphate-based surfactant in a range between 300 ppm and 3000 ppm, both inclusive, with respect to a weight of the zinc in the negative electrode, the phosphate-based surfactant having an average molecular weight in a range between 100 and 500, both inclusive.

3. The AA alkaline dry battery of claim 1, wherein
the electrolyte has a concentration of potassium hydroxide in a range between 26.0 wt % and 33.5 wt %, both inclusive.

4. The AA alkaline dry battery of claim 1, wherein
the manganese dioxide has a weight of 9.30 g or more.

5. An AAA alkaline dry battery, comprising:
a positive electrode containing manganese dioxide;
a negative electrode containing zinc of 1.71 g or more and bismuth in a range between 5 ppm and 100 ppm, both inclusive; and
an electrolyte of 1.77 g or more containing an aqueous solution of potassium hydroxide, the electrolyte having a concentration of potassium hydroxide in a range between 26.0 wt % and 34.0 wt %, both inclusive.

6. The AAA alkaline dry battery of claim 5, wherein
the electrolyte contains a phosphate-based surfactant in a range between 300 ppm and 3000 ppm, both inclusive, with respect to a weight of the zinc in the negative electrode, the phosphate-based surfactant having an average molecular weight in a range between 100 and 500, both inclusive.

7. The AAA alkaline dry battery of claim 5, wherein
the manganese dioxide has a weight of 4.05 g or more.
